(19) United States
(12) Patent Application Publication
(10) Pub. No.: US 2026/0141289 A1
(43) Pub. Date: May 21, 2026

(54) IMPROVED CONTEXTUAL BANDITS MACHINE LEARNING MODEL FOR COLD START APPLICATIONS

(71) Applicant: Intuit Inc., Mountain View, CA (US)

(72) Inventors: Aleksandr KIM, Tel Aviv (IL); Yaakov TAYEB, Petah Tikva (IL)

(73) Assignee: Intuit Inc., Mountain View, CA (US)

(21) Appl. No.: 18/952,633

(22) Filed: Nov. 19, 2024

(51) Int. Cl. G06N 20/00

(52) U.S. Cl. CPC G06N 20/00

(57) ABSTRACT

A method of improving a contextual bandits machine learning model. A training controller is applied to an untrained model, which includes a contextual bandits machine learning model, and training data to generate a trained model. Applying the training controller includes an iterative process that is repeated until convergence. The iterative process includes executing the untrained model on the training data, which includes both privileged information and non-privileged information, to generate a prediction output. A reward is determined, and an updated model is generated based on the reward. The training data, which includes the non-privileged information and excludes the privileged information, is applied to the updated model to generate a test output. A comparison of the test output and the prediction output is used to determine whether convergence has been achieved. The updated model includes the trained model when convergence is achieved.

### BACKGROUND

Computer models are used to evaluate situations and make predictions. Based on the predictions, the computer models may present a recommendation to a user. In some instances, the computer models may have limited access to user information when making the prediction. As a result of the limited access to the user information, the recommendation provided may result in a negative outcome from the user. Such instances in which the computer models have limited access to the user information when making predictions and recommendations may be referred to as a “cold start” challenge.

The cold start challenge may be present when a contextual bandits (CB) model is used to generate a recommendation. The CB model relies upon initial features that provide context for a recommendation generated for a user. However, in instances where there are few initial features or only one initial feature provided, the CB model may not have enough information to provide a robust recommendation. Thus, a challenge exists in improving CB models that face “cold start” challenges.

### SUMMARY

One or more embodiments provide for a method of improving a contextual bandits machine learning model and an output of the contextual bandits model. The method includes applying a training controller to an untrained model and training data to generate a trained model. The untrained model includes a contextual bandits one-step reinforcement learning machine learning model and the training data includes both privileged information and non-privileged information. Applying the training controller includes an iterative process that repeats until convergence. The iterative process includes executing the untrained model on the training data to generate a prediction output. Both the privileged information and the non-privileged information are applied while executing the untrained model. The iterative process also includes determining a reward based on the prediction output relative to a correct result and updating the untrained model according to the reward to generate an updated model. The iterative process also includes applying the training data to the updated model to generate a test output. The non-privileged information is applied while applying the training data to the updated model while excluding application of the privileged information while applying the training data to the updated model. The iterative process also includes comparing the prediction output to the test output to generate a comparison and determining whether convergence is achieved. Convergence is achieved when the comparison satisfies a threshold. Upon determining that convergence is achieved, the updated model includes the trained model. The method also includes presenting the trained model.

One or more embodiments provide for a system of improving a contextual bandits machine learning model and an output of the contextual bandits model The system includes a computer processor and a data repository in communication with the computer processor. The data repository stores training data, which includes privileged information and non-privileged information. The data repository also stores a prediction output, a reward, a correct result, a test output, a comparison, and a threshold. The system also includes an untrained model the untrained training model includes a contextual bandits one-step reinforcement learning machine learning model. The system also a trained model trained from the untrained model. The system also includes a training controller that when executed by the computer processor, performs an iterative process that repeats until convergence. Executing the untrained model on the training data includes generating a prediction output. Both the privileged information and the non-privileged information are applied while executing the untrained model. Executing the untrained model on the training data also includes determining a reward based on the prediction output relative to a correct result and updating the untrained model according to the reward to generate an updated model. Executing the untrained model on the training data also includes applying the training data to the updated model to generate a test output. The non-privileged information is applied while applying the training data while excluding application of the privileged information while applying the training data. Executing the untrained model on the training data also includes comparing the prediction output to the test output to generate a comparison and determining whether convergence is achieved. Convergence is achieved when the comparison satisfies a threshold. Upon determining that convergence is achieved, the updated model includes the trained model. The system also includes a server controller which, when executed by the computer processor, presents the trained model.

One or more embodiments provide for a method of improving a contextual bandits machine learning model and an output of the contextual bandits model. The method includes applying a training controller to an untrained model and training data to generate a trained model. The untrained model includes a contextual bandits one-step reinforcement learning machine learning model and the training data includes both privileged information and non-privileged information. Applying the training controller includes an iterative process that repeats until convergence. The iterative process includes executing the untrained model on the training data to generate a prediction output. Both the privileged information and the non-privileged information are applied while executing the untrained model. The iterative process also includes determining a reward based on the prediction output relative to a correct result and updating the untrained model according to the reward to generate an updated model. The iterative process also includes applying the training data to the updated model to generate a test output. The non-privileged information is applied while applying the training data while excluding application of the privileged information while applying the training data. The iterative process also includes comparing the prediction output to the test output to generate a comparison and determining whether convergence is achieved. Convergence is achieved when the comparison satisfies a threshold. Upon determining that convergence is achieved, the updated model includes the trained model. The method also includes presenting the trained model. The method also includes applying the trained model to unknown data to generate a plurality of inferences and re-training, to generate a retrained model, the trained model on new training data. The new training data includes at least the unknown data and the plurality of inferences.

Other aspects of one or more embodiments will be apparent from the following description and the appended claims.

### BRIEF DESCRIPTION OF DRAWINGS

FIG. 1A shows a computing system, in accordance with one or more embodiments.

FIG. 1B shows details of the training controller of FIG. 1A.

FIG. 2A shows a flowchart of a method for training contextual bandits models, in accordance with one or more embodiments.

FIG. 2B shows a flowchart of a method for training contextual bandits models, in accordance with one or more embodiments.

FIG. 3 shows an example of a data flowchart for providing a trained contextual bandits model, in accordance with one or more embodiments.

FIG. 4 shows an example of providing a recommendation, in accordance with one or more embodiments.

FIG. 5A and FIG. 5B show an example of a computing system and network environment, in accordance with one or more embodiments.

Like elements in the various figures are denoted by like reference numerals for consistency.

### DETAILED DESCRIPTION

One or more embodiments are directed to training and improving contextual bandits (CB) machine learning models (also referred to as a “CB model”) to generate a predicted output when limited contextual information is available at inference time (e.g., the cold start challenge). In particular, one or more embodiments provide for training an untrained CB model using a wider range of data relative to data available when applying the untrained CB model in real-world conditions. More specifically, the untrained CB model is trained with both privileged information (e.g., information not available during application of the CB model in real-world conditions) and non-privileged information (e.g., information available during application of the CB model in real-world conditions). The trained CB model may then be applied to operational data during a practical application in order to generate a recommendation to a user based on limited and non-privileged information of the user.

Traditional CB models work efficiently in scenarios where features that provide context about the user are available. However, in scenarios such as the cold start challenge, the features may be limited or non-existent. Thus, the technical challenge is, again, providing a recommendation to a user using a CB model when limited initial features describing the user are available.

The technical solution to the technical challenge is training the CB model using privileged information and non-privileged information from existing users. Such training permits the trained CB model to better predict a recommendation for a new user based on limited features describing the new user, because the trained CB model is able to correlated the limited features describing the new user to like features of existing users. Stated differently, use of privileged information during training of the untrained CB model improves the final trained CB model by providing additional relevant data during training so that, during an inference phase, the trained CB model is more capable of grouping users together based on the privileged information. Thus, the trained CB model can match the new user with one of the groups of existing users with like features for which adequate information is available. Specifically, the prediction regarding the new user is based on the group of like existing users that most closely matches the new user. Thus, the trained CB model thereby provides for a more accurate prediction relative to traditional CB models trained without privileged information.

As a specific example, limited information about a new user includes a geographic location of the new user. The geographic location is provided as input to a trained CB model, trained as described herein. Specifically, the trained CB model was trained on known information about existing users, permitting the trained CB model to group existing user together based on like features such as user demographics, prior purchase history of each user, financial scores of the user, etc. The trained CB model may match the new user to a group of existing users based on the geographic location of the new user and the group of existing users. The trained CB model will then generate a recommendation that is more likely to be accurate, relative to a prediction by some other model. Such recommendation can then be presented to an automated process, to the new user, or to a third party.

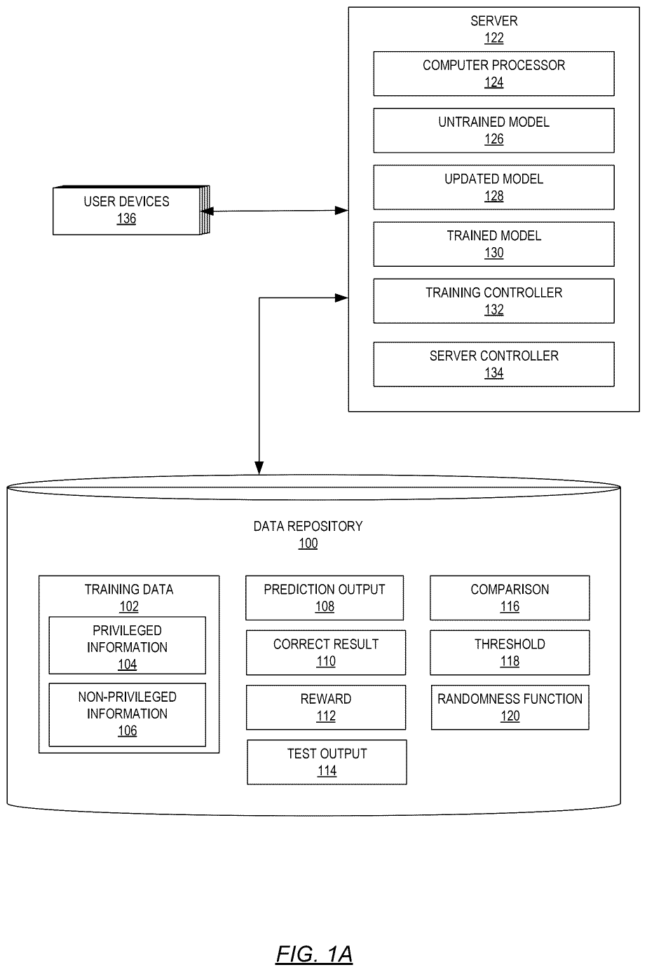

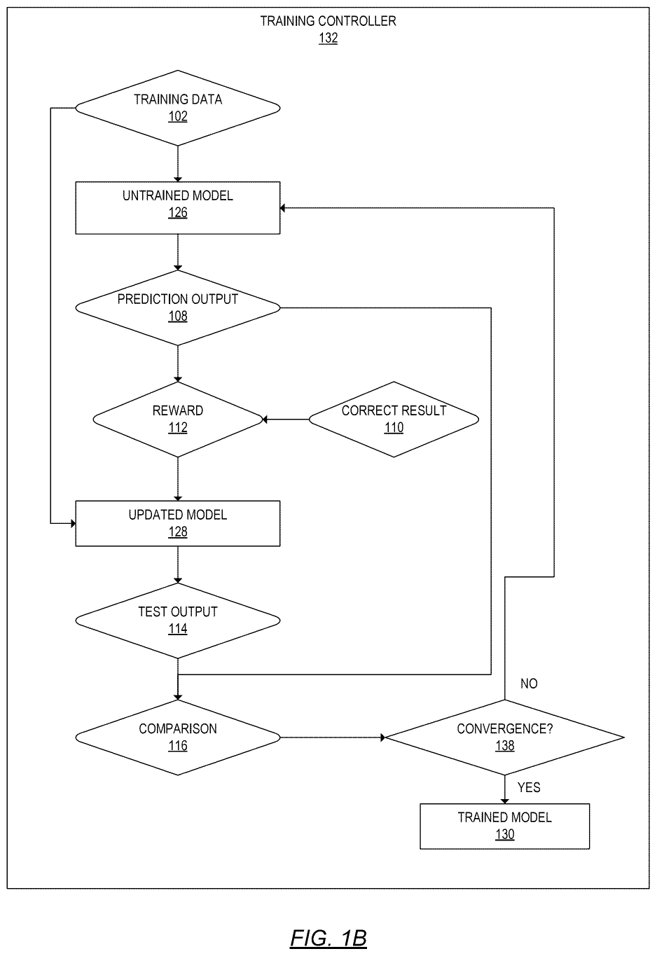

Attention is now turned to the figures. FIG. 1A shows a computing system, in accordance with one or more embodiments. The system shown in FIG. 1A includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) stores training data (102). Training data (102) is a set of information which is used to train machine learning models as described below. The training data (102) includes details, facts, and other information which is operated on by the models to generate output. For example, training data (102) for a model to determine a recommendation to present a user may include geographic location, customer age, the results of prior predictions of an untrained model (126), an updated model (128), or a trained model (130) (defined below), metadata about the data, labels indicating the correctness of data, etc. The training data (102) also includes information about existing users that are already known.

The training data (102) may include privileged information (104) and non-privileged information (106). Privileged information (104) is at least the set of training data (102) that corresponds to features relating to one or more existing users for which adequate information is known. “Adequate” information is defined as sufficient information such that the untrained model (126) (defined below) may take, as input, the privileged information (104) and may generate, as output when executed, a result that is within a pre-determined accuracy of a correct result (110) (defined below).

The privileged information (104) also may include data that does not yet exist during the inference stage, such as a potential customer's product usage data, but which is added later when the updated model (128) or the trained model (130) are later retrained. In other words, the privileged information (104) may be obtained from the potential customer when they become an existing customer.

The privileged information (104) may also be personal details of an existing customer which are prohibited from distribution, such as due to availability, cost of collection, data storage policy, or legal restrictions. The personal details may be used to determine why a prediction was correct or incorrect.

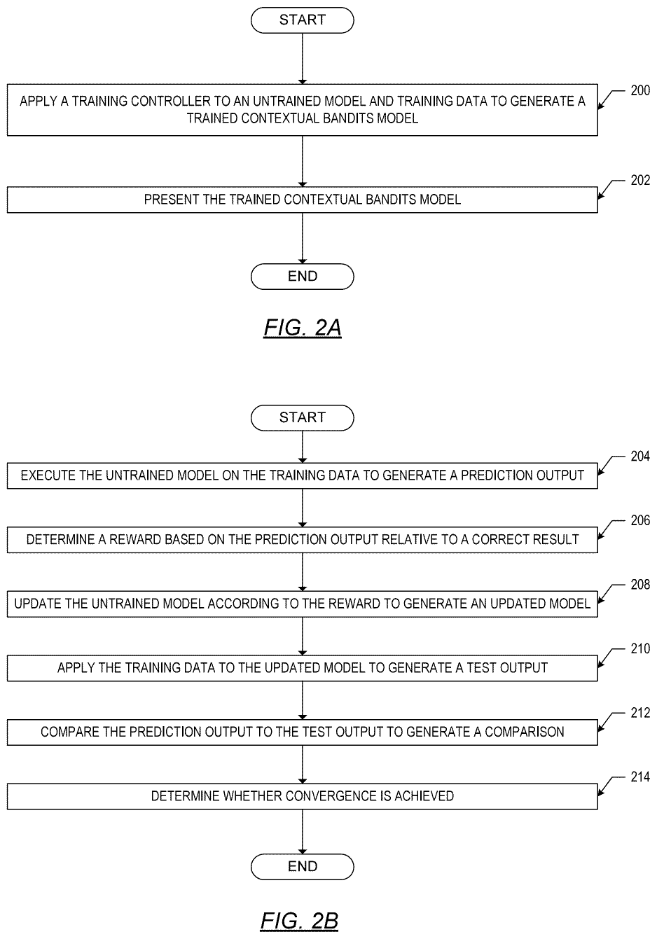

The privileged information (104) is not available during a test phase of training, whether by design (i.e., the privileged information (104) is deliberately excluded during the test phase) or by circumstance (i.e., the privileged information (104) is unavailable during the test phase). Regardless, the privileged information (104) is used during training of an untrained model (126) and more specifically, during a prediction phase and a reward phase, as described in FIG. 1B and FIG. 2B.

Non-privileged information (106) is the set of training data (102) that is not privileged information. Most commonly, the non-privileged information (106) is data regarding an unknown or new user during an inference phase, and such data is inadequate. “Inadequate” data is defined as an amount of data that, when used as input in the untrained model (126), causes the untrained model (126) to output a result that is incorrect, inappropriate (as determined by a monitoring machine learning model or a computer scientist monitoring the system of FIG. 1), or inaccurate (as determined by the monitoring machine learning model or the computer scientist.)

In some instances, the non-privileged information (106) corresponds to initial features or data of the one or more existing users when the one or more existing users were new users. Non-privileged information (106) may be available during the training stage and is present at the inference stage. Non-privileged information (106) reflects the type of information expected to be available to the trained model such as, for example, operational data. The non-privileged information (106) omits data, such as feedback, that may be delayed in operational situations.

The data repository (100) also stores a prediction output (108). The prediction output (108) is a prediction by the untrained model (126) of what an existing user will select when presented with two or more outputs. The prediction output (108) is generated by the untrained model (126) using the privileged information (104) and the non-privileged information (106). The prediction output (108) may include, for example, a recommendation to the existing user based on a prediction that the existing user will select the recommendation.

The data repository (100) also stores a correct result (110). The correct result (110) is the result expected based on the privileged information (104) of the training data (102) when the untrained model (126) is executed on the training data (102). In other words, the output of the untrained model (126) is treated as being the correct result (110) when executed on the privileged information (104).

The data repository (100) also stores a reward (112). The reward (112) prescribes a value to the prediction output (108) and describes, for example, whether the prediction output (108) was accurate or was inaccurate. The reward (112) can be a negative reward when, for example, the prediction output (108) is different from the correct result (110). Similarly, the reward (112) can be a positive reward when, for example, the prediction output is the same as the correct result (110). Use of the reward (112) during training of the untrained model (126) is described in FIGS. 1B and 2B.

The data repository (100) also stores a test output (114). The test output (114) is a prediction by the updated model (128) of what a new user will select when presented with two or more outputs. The test output (108) is generated by the updated model (128) using the non-privileged information (106) and excluding the privileged information (104). The test output (114) may include, for example, a recommendation to the new user based on a prediction that the new user will select the recommendation.

The data repository (100) also stores a comparison (116). The comparison (116) is a comparison of the test output (114) and the prediction output (108). The comparison (116) is a measure of a degree to which the test output (114) and the prediction output (108) match. In some instances, the comparison (116) may be how far the values of the test output (114) and the prediction output (108) are from each other. “How far” means a numerical distance between the prediction output (108) and the test output (114). In other instances, the comparison (116) may have a value of zero when the prediction output (108) and the test output (114) do not match and a value of one when the prediction output (108) and the test output (114) match.

The data repository (100) also stores a threshold (118). The threshold (118) is a limit to which the comparison (116) is compared. The threshold (118) can be, for example, a percentage, a number, or any other value. The threshold (118) may be determined automatically by, for example, by the server controller (134), semi-automatically by the server controller (134) and a user, or by the user.

The data repository (100) also stores a randomness function (120). The randomness function (120) is an algorithm that modifies the trained model (130) and/or the training data (102). By modifying the model in question, the randomness function (120) controls an output of the trained CB model and adjusts the trained model (130) and/or the training data (102) to produce the output. In other words, the randomness function (120) adjusts the trained model (130) and/or the training data (102) to produce a desired output. The randomness function (120) may be, for example, an epsilon-greedy algorithm, an upper confidence bound algorithm, or a Thompson sampling algorithm.

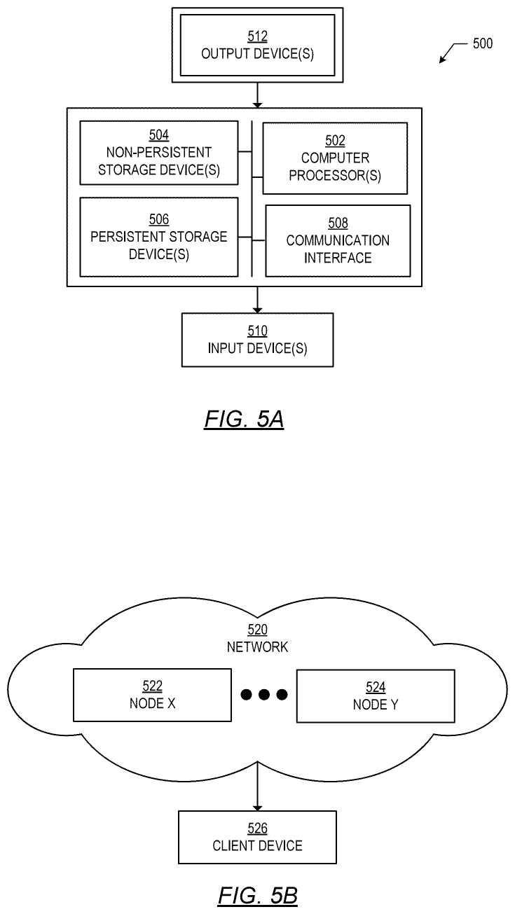

The system shown in FIG. 1A may include other components. For example, the system shown in FIG. 1A also may include a server (122). The server (122) is one or more computer processors, data repositories, communication devices, and supporting hardware and software. The server (122) may be in a distributed computing environment. The server (122) is configured to execute one or more applications, such as the untrained model (126), the updated model (128), or the trained model (130). An example of a computer system and network that may form the server (122) is described with respect to FIG. 5A and FIG. 5B.

The server (122) includes a computer processor (124). The computer processor (124) is one or more hardware or virtual processors which may execute computer readable program code that defines one or more applications, such as the untrained model (126), the updated model (128), or the trained model (130). An example of the computer processor (124) is described with respect to the computer processor(s) (502) of FIG. 5A.

The server (122) also includes an untrained model (126). The untrained model (126) is a reinforcement learning machine learning model. More specifically, an example of the untrained model (126) may be a CB one-step reinforcement learning machine learning model. However, many reinforcement models may be used. Training the trained model (130) is described with respect to FIG. 1B.

The server (122) also includes an updated model (128). The updated model (128) is the untrained model (126) that is updated during an update phase of the training process based on the reward (112), as will be described with respect to FIG. 1B.

The server (122) also includes a trained model (130). The trained model (130) is the untrained model (126) after the untrained model (126) has reached convergence during training. Training is described with respect to FIG. 1B.

The server (122) also may include a training controller (132). The training controller (132) is software or application specific hardware which, when executed by the computer processor (124), trains one or more untrained models (e.g., the untrained model (126)). The training controller (132) is described in more detail with respect to FIG. 1B.

The server (122) also may include a server controller (134). The server controller (134) is software or application specific hardware which, when executed by the computer processor (124), controls and coordinates operation of the software or application specific hardware described herein. Thus, the sever controller (134) may control and coordinate execution of the untrained model (126), the updated model (128), the trained model (130), and the training controller (132).

The system shown in FIG. 1A also may include one or more user devices (136). The user devices (136) may be considered remote or local. A remote user device is a device operated by a third-party (e.g., an end user of an online service) that does not control or operate the system of FIG. 1A. Similarly, the organization that controls the other elements of the system of FIG. 1A may not control or operate the remote user device. Thus, a remote user device may not be considered part of the system of FIG. 1A.

In contrast, a local user device is a device operated under the control of the organization that controls the other components of the system of FIG. 1A. Thus, a local user device may be considered part of the system of FIG. 1A. In any case, the user devices (136) are computing systems (e.g., the computing system (500) shown in FIG. 5A) that communicate with the server (122).

While FIG. 1A shows a configuration of components, other configurations may be used without departing from the scope of one or more embodiments. For example, various components may be combined to create a single component. As another example, the functionality performed by a single component may be performed by two or more components.

Attention is turned to FIG. 1B, which shows the details of the training controller (132). In general, machine learning models are trained prior to being deployed. The process of training a model, briefly, involves iteratively testing a model against test data for which the final result is known, comparing the test results against the known result, and using the comparison to adjust the model. The process is repeated until the results do not improve more than some pre-determined amount, or until some other termination condition occurs. After training, the final adjusted model is applied to unknown data (i.e., data for which the actual result is not known) in order to make predictions.

Training starts with training data (102). The training data (102) may be privileged information (104) and/or the non-privileged information (104) from FIG. 1A.

More generally, the training data (102) is provided as input to the untrained model (126) from FIG. 1A. The untrained model (126) may be characterized as a program that has adjustable parameters. The program is capable of learning and recognizing patterns to make predictions. The output of the untrained model (126) may be changed by changing one or more parameters of the untrained model (126). The one or more parameters may be one or more weights, a hyperparameter, or possibly many different variations that may be used to adjust the output of the function of the untrained model (126).

The untrained model (126) is then executed on the training data (102) including both the privileged information (104) and the non-privileged information (106). The result is the prediction output (108) from FIG. 1A, which is a prediction which the untrained model (126) has been programmed to output during a prediction phase.

The prediction output (108) is used to generate the reward (112), from FIG. 1A, during a reward phase. The reward (112) is generated based on a comparison between the prediction output (108) and the correct result (110) from FIG. 1A. As previously described, when the prediction output (108) and the correct result (110) do not match, a negative reward is generated. When the prediction output (108) and the correct result (110) match, a positive reward is generated. The reward (112) is used to update the untrained model (126) to generate the updated model (128) from FIG. 1A, during an update phase.

The updated model (128) is then executed on the training data (102) using only the non-privileged information (106) during a test phase to generate the test output (114) from FIG. 1A. In other words, the privileged information (106) is excluded during the test phase. The test output (114) is compared to the prediction output (108) to yield the comparison (116) from FIG. 1A during a comparison phase.

The comparison (116) is provided to a convergence process (138). The convergence process (138) is programmed to achieve convergence during the training process. Convergence is a state of the training process, described below, in which a pre-determined end condition of training has been reached. The pre-determined end condition may vary based on the type of untrained model (126) being used (supervised versus unsupervised machine learning) or may be pre-determined by a user (e.g., convergence occurs after a set number of training iterations, described below).

The convergence process (138) compares the comparison (116) to the threshold (118) and a determination is made whether the comparison (116) matches the threshold (118) to a pre-determined degree. The pre-determined degree may be an exact match, a match to within a pre-specified percentage, or some other metric for evaluating how closely the comparison (116) matches the threshold (118). In some instances, convergence may occur when the comparison (116) matches the threshold (118) to within a pre-specified percentage.

For example, the pre-determined degree may be 95%. In this case, when the untrained model (126) accuracy reaches 95% (representing that in 95 times out of 100 query predictions the untrained model (126) correctly predicted that a user would choose the recommendation generated by the untrained model (126)) then convergence occurs. If convergence has not occurred (a “no” at the convergence process (138)), then executing the untrained model (126) on the training data (102), the prediction phase, the reward phase, the update phase, the test phase, and the comparison phase may be repeated until convergence is achieved. Upon convergence (a “yes” result at the convergence process (138)), the untrained model (126)—and more specifically, the updated model (128)—is deemed to be a trained model (130). During deployment, the trained model (130) is executed again, but this time on unknown data for which the final result is not known. The output of the trained model (130) is then treated as a prediction of the information of interest relative to the unknown data.

FIG. 2A shows a flowchart of a method for training an untrained CB machine learning model to generate an improved, trained CB machine learning model, in accordance with one or more embodiments. The method of FIG. 2A may be implemented using the system of FIG. 1A and one or more of the steps may be performed on or received at one or more computer processors.

Step 200 includes applying a training controller to an untrained model and training data to generate a trained model. The training controller generates the trained predictive model using an iterative process that repeats until convergence, as described above with respect to FIG. 1B above and FIG. 2B below.

As previously described, the trained model has a higher chance of success for predicting a recommendation as compared to the untrained model. This is due to the trained model utilizing privileged information and non-privileged information of existing users to train the model. The privileged information and non-privileged information of existing users can be used to group users with like features. During an inference phase, the trained model can then match limited features of a new user to like features of the existing users. Then, based on the match, the trained model can generate a recommendation that would result in a positive response from the existing users and thus, would have a higher chance of a positive response from the new user as well.

Step 202 includes presenting the trained model. The trained model may be presented by, for example, a server controller. Presenting the trained model may include deploying the trained model on a server and receiving a production input. After the production input is received, the trained model may be executed on the production input to generate a production prediction related to the production input. In such instance, the privileged information is excluded while executing the trained model on the production input.

Additionally, after the model is presented, a randomness function may be applied to the trained model to generate a modified updated model. The modified updated model may then be re-executed on the training data to generate one or more new prediction outputs. The training controller may then be re-applied to the modified updated model and new training data to generate a modified trained model. In such instances, the new training data includes at least the one or more new prediction outputs. The new training data can also include the training data (e.g., at least the privileged information and/or the non-privileged information). The new training data may also correspond to at least one or more subsets of users for which a corresponding prediction output was modified to generate the one or more new prediction outputs.

After the modified trained model is generated, the randomness function may be adjusted. Adjusting the randomness function includes estimating a confidence interval and adjusting the randomness function based on the confidence interval. Estimating the confidence interval includes re-executing the modified updated model on at least one subset of training data of the training data to generate a corresponding set of bootstrapped prediction outputs. The bootstrapped prediction outputs have different prediction outputs for the same subset of training data. Then, a prediction variance is calculated for each set of the corresponding set of boot strapped prediction outputs and the confidence interval is estimated using the prediction variance.

Alternatively, or additionally, after the modified trained model is generated, the modified trained model may be applied to unknown data to generate a number of inferences. The modified trained model may be retrained on new training data to generate a modified retrained model. The new training data includes at least the unknown data and the inferences. The new training data may also include, for example, the training data (e.g., at least the privileged information and/or the non-privileged information).

While the various steps in this flowchart are presented and described sequentially, at least some of the steps may be executed in different orders, may be combined or omitted, and at least some of the steps may be executed in parallel. Furthermore, the steps may be performed actively or passively.

FIG. 2B shows a flowchart of a method for executing the training controller on the untrained CB machine learning model, in accordance with one or more embodiments. The method of FIG. 2B may be implemented using the system of FIG. 1A and one or more of the steps may be performed on or received at one or more computer processors. The method of FIG. 2B may be executed during the step 200 of the method described in FIG. 2A.

Step 204 includes executing the untrained model on the training data to generate a prediction output. During the step 204, both the privileged information and the non-privileged information of the training data are applied while executing the untrained model. The untrained model utilizes the privileged information (that would otherwise not be available during an inference phase) and the non-privileged information to group existing users together in a number of different groups based on like features. Then, the prediction output can be generated for an existing user of one of the groups using the privileged information and the non-privileged information. More specifically, the privileged information can be used to inform the untrained model of how the group will likely react with respect to the prediction output. Thus, the untrained model will generate the prediction output which will likely result in a positive reaction from the group.

Step 206 includes determining a reward based on the prediction output relative to a correct result during the reward phase. The reward is determined based on whether the prediction output matches the correct result. As previously described, the correct result may be a known result obtained from the privileged information. In instances where the prediction output and the correct result do not match, the reward may be a negative reward. In instances where the prediction output and the correct result do match, the reward may be a positive reward.

Step 208 includes updating the untrained model according to the reward to generate an updated model during the update phase. Updating the untrained model may include updating one or more parameters, weights, etc. of the untrained model.

Step 210 includes applying the training data to the updated model to generate a test output during the test phase. The non-privileged information is applied during the step 210 while the privileged information is excluded during the step 210. During the test phase, the non-privileged information is applied to mimic an inference phase where the only information provided to the model is non-privileged information. Thus, during the test phase, limited features about a test user obtained from the non-privileged information is provided as input to the updated model. The updated model matches the limited features of the test user to like features of one of the groups as determined in step 204. Then, the updated model generates a test output based on the match. The test output is one that the existing users of the group would respond favorably to and thus, the test user would also more likely positively respond to the test output.

Step 212 includes comparing the prediction output to the test output to generate a comparison. Such comparison informs the training controller if the updated model was sufficiently updated to generate a test output that matches or nearly matches the prediction output. Comparing the prediction output to the test output may include calculating a difference between the prediction output and the test output. The comparison can be used to determine if the model is sufficiently trained before the training is concluded, as described below.

Step 214 includes determining whether convergence is achieved. Determining whether convergence is achieved can include comparing the comparison to a threshold. In such embodiments, convergence is achieved when the comparison satisfies the threshold. In other embodiments, convergence may be achieved after a set number of iterations of the steps 204-212 are completed. The updated model becomes the trained model when convergence is determined to have been achieved.

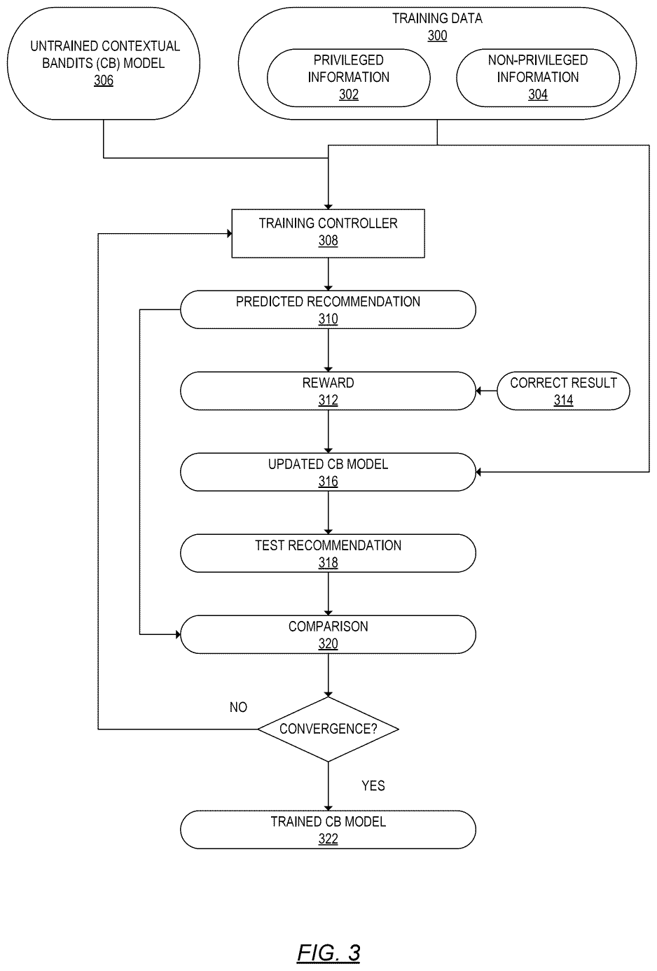

FIG. 3 shows an example of a data flow for providing a trained CB model, in accordance with one or more embodiments. The following example is for explanatory purposes only and not intended to limit the scope of one or more embodiments.

The trained CB model is provided by completing a training process using an untrained CB model. To begin the training process, the untrained CB model (306) may be provided for training. In some instances, the untrained CB model (306) can be a previously trained CB model which is being retrained, for example, based on new training data. The new training data can include, for example, new privileged information and/or new non-privileged information obtained from new users.

The untrained CB model (306) can be trained using training data (300) (which may include the new training data described above). As previously described, non-privileged information (304) of the training data (300) includes data similar to the unknown data expected to be encountered during an inference phase. For example, non-privileged information (304) may include information about a new user that is limited to a geographic location of the new user. Non-privileged information (304) can also include limited information of a new user that later becomes an existing user. In other words, the non-privileged information (304) can be limited data of the existing user when the existing user was a new user. Privileged information (302) of the training data (300) includes known data that is not available during an inference phase of a trained CB model (322). For example, privileged information (302) of existing users may include services and/or products that the existing users purchased, as well as demographics, income ranges, etc. of the existing users.

The training controller (308) is applied to the privileged information (302), the non-privileged information (304), and the untrained predictive model (306) to generate a predicted recommendation (310). The untrained predictive model (306) groups existing users with like features together using the privileged information (302) and the non-privileged information (304). The predicted recommendation (310) correlates to a recommended option that the untrained predictive model (306) predicts that an existing user of a group of existing users will choose based on the privileged information (302) and the non-privileged information (304) of the group. For example, the privileged information (302) may include information that a majority of the existing users of the group have previously purchased monthly subscriptions for several different services. Thus, the predicted recommendation (310) or the recommended option may then be generated to present a monthly subscription as opposed to a yearly subscription to the existing user of the group.

The predicted recommendation (310) is used to determine a reward (312). The reward (312) may be determined based on whether the predicted recommendation (310) matches a correct result (314). As previously described, the correct result (314) may be determined based on the privileged information (302). In instances where the correct result (314) matches the predicted recommendation (310), a positive reward will be generated. In instances where the predicted recommendation (310) does not match the correct result (314), a negative reward will be generated. For example, though the privileged information (302) of the group as described above may suggest that most existing users of the group purchased a monthly subscription, whereas one existing user of the group may have in fact purchased a yearly subscription. Thus, the correct result (314) for the one existing user may be to recommend the yearly subscription (because the one existing user purchased the yearly subscription) whereas the predicted recommendation (310) may be to recommend the monthly subscription. In other examples, another existing user of the group may have in fact purchased a monthly subscription. In such examples, a positive reward will be generated as the predicted recommendation (310) to recommend the monthly subscription matches the correct result (314) of the existing user purchasing the monthly subscription.

The reward (312) is then used to update the untrained CB model (306) to generate an updated CB model (316). The updated CB model (316) is then executed on the non-privileged information (304) to generate a test recommendation (318) during a test phase. As previously described, the test phase mimics an inference phase in that the privileged information (302) is excluded during execution of the updated CB model (316).

The test recommendation (318) is then compared to the predicted recommendation (310) to generate a comparison (320). The comparison (320) is compared to a threshold to determine if convergence has been reached.

As described above with respect to FIG. 1B, convergence may occur when successive iterations result in the comparison (320) reaching or meeting a threshold by a pre-determined degree. Convergence may also occur after a set number of training iterations.

At convergence, the training process ends, and a current version of the updated CB model (316) is used during an inference phase. In other words, once the comparison (320) reaches or meets the threshold by the pre-determined degree or the set number of training iterations has occurred, the updated CB model (316) is considered the trained CB model (322).

As previously discussed, the technical challenge is providing a recommendation to a user using a CB model with limited initial features of the user. The training process above describes the technical solution to the technical challenge. More specifically, the training process above utilizes privileged information and non-privileged information to train an untrained CB model. By using both the privileged information and the non-privileged information, the untrained CB model can group like features of existing users. The trained CB model can then better predict a recommendation for a new user based on features from the new user that correspond to like features of the existing users.

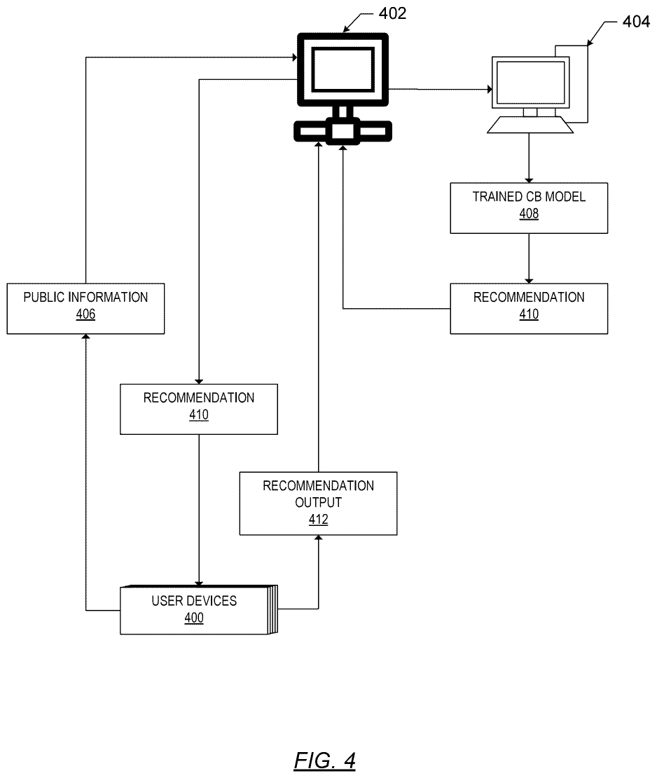

FIG. 4 shows an example of providing a recommendation, in accordance with one or more embodiments. The following example is for explanatory purposes only and not intended to limit the scope of one or more embodiments.

A user device (400) may interface with a server (402) to access, for example, a virtual service (e.g., a financial service, a streaming service, etc.). The server (402) may have access to public information (406) about the user device (400) and/or a user of the user device (400). The public information (406) is information about the user, and may include, for example, a location of the user device (400), a type of user device (400), etc. The public information (406) can be used on its own by an untrained CB model to generate a recommendation.

However, the public information (406) alone is insufficient for the untrained CB model to generate a satisfactory result as the public information (406) does not provide enough information about the user. For example, the recommendation may be whether to highlight a monthly subscription or an annual subscription for a service to a user. In such example, the public information (406) may only include information about the location of the user device (400). However, the public information (406) may not include information such as whether the user typically purchases monthly subscriptions for other services. Thus, the untrained CB model does not have enough information to generate a recommendation to highlight either the monthly subscription or the annual subscription for a service to a user.

However, a trained CB model (408) provides an improvement over the untrained CB model and may have a higher success of generating a recommendation that will generate a positive response from the user. The trained CB model (408) does so by using privileged information and non-privileged information during training to group like features of existing users together, as described in FIGS. 1B and 2B. The trained CB model (408) can then match the limited public information (406) to like features of the existing users. The trained CB model (408) can then generate a recommendation that will generate a positive response from the existing users and will have a higher success of generating a positive response from the user as well.

Thus, once the public information (406) is received by the server (402), the server (402) transmits the public information (406) to a computing device (404). The computing device (404) stores and can execute the trained CB model (408), which was described above. The computing device (404) inputs the public information (406) into the trained CB model (408), which outputs a recommendation (410). The recommendation (410) may be a predicted option that the trained CB model (408) predicts that the user device (400) will select. As previously described, the recommendation (410) may be to highlight or more prominently show a monthly payment for a subscription as opposed to a yearly payment for the subscription.

The computing device (404) transmits the recommendation (410) to the server (402) and the server (402) transmits the recommendation (410) to the user device (400). The user may then select an option provided in the recommendation or may select a different option via the user device (400). The user device (400) may then transmit a recommendation output (412) correlating to the option that the user device (400) selected (e.g., whether the recommendation (410) was selected or not) to the server (402). The recommendation output (412) can then be transmitted to the computing device (404) and used to retrain the trained CB model (408) for further refinement.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5A, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores, or micro-cores, of a processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device, and combinations thereof.

Further, the output device(s) (512) may include a display device, a printer, external storage, or any other output device. One or more of the output device(s) (512) may be the same or different from the input device(s) (510). The input device(s) (510) and output device(s) (512) may be locally or remotely connected to the computer processor(s) (502). Many different types of computing systems exist, and the aforementioned input device(s) (510) and output device(s) (512) may take other forms. The output device(s) (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (502), is configured to perform one or more embodiments, which may include transmitting, receiving, presenting, and displaying data and messages described in the other figures of the disclosure.

The computing system (500) in FIG. 5A may be connected to, or be a part of, a network. For example, as shown in FIG. 5B, the network (520) may include multiple nodes (e.g., node X (522) and node Y (524), as well as extant intervening nodes between node X (522) and node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522) and node Y (524)) in the network (520) may be configured to provide services for a client device (526). The services may include receiving requests and transmitting responses to the client device (526). For example, the nodes may be part of a cloud computing system. The client device (526) may be a computing system, such as the computing system shown in FIG. 5A. Further, the client device (526) may include or perform all or a portion of one or more embodiments.

The computing system of FIG. 5A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
applying a training controller to an untrained model and training data to generate a trained model, wherein:
the untrained model comprises a contextual bandits one-step reinforcement learning machine learning model,
the training data comprises both privileged information and non-privileged information,
wherein applying the training controller comprises an iterative process that repeats until convergence, the iterative process comprising:
executing the untrained model on the training data to generate a prediction output, wherein both the privileged information and the non-privileged information are applied while executing the untrained model,
determining a reward based on the prediction output relative to a correct result,
updating the untrained model according to the reward to generate an updated model,
applying the training data to the updated model to generate a test output, wherein the non-privileged information is applied while applying the training data while excluding application of the privileged information while applying the training data,
comparing the prediction output to the test output to generate a comparison, and
determining whether convergence is achieved, wherein convergence is achieved when the comparison satisfies a threshold;
wherein, upon determining that convergence is achieved, the updated model comprises the trained model; and
presenting the trained model.

2. The method of claim 1, wherein the privileged information corresponds to features relating to one or more existing users.

3. The method of claim 2, wherein the non-privileged information corresponds to initial features of the one or more existing users.

4. The method of claim 1, further comprising:
applying a randomness function to the trained model to generate a modified updated model;
re-executing the modified updated model on the training data to generate one or more new prediction outputs; and
re-applying the training controller to the modified updated model and new training data to generate a modified trained model,
wherein the new training data includes at least the one or more new prediction outputs.

5. The method of claim 4, wherein the new training data corresponds to at least one or more subsets of users for which a corresponding prediction output was modified to generate the one or more new prediction outputs.

6. The method of claim 4, wherein the randomness function comprises at least one of an epsilon-greedy algorithm, an upper confidence bound algorithm, and a Thompson sampling algorithm.

7. The method of claim 4, wherein the randomness function further modifies the training data.

8. The method of claim 4, wherein presenting the trained model comprises deploying the trained model on a server, and wherein the method further comprises:
receiving a production input; and
executing the trained model on the production input to generate a production prediction related to the production input, wherein the privileged information is excluded while executing the trained model on the production input.

9. The method of claim 4, further comprising:
applying the modified trained model to unknown data to generate a plurality of inferences; and
re-training, to generate a modified retrained model, the modified trained model on new training data, wherein the new training data comprises at least the unknown data and the plurality of inferences.

10. The method of claim 4, further comprising:
adjusting the randomness function after re-executing the modified updated model on the training data.

11. The method of claim 10, wherein adjusting the randomness function comprises:
estimating a confidence interval, wherein estimating the confidence interval comprises:
re-executing the modified updated model on at least one subset of training data of the training data to generate a corresponding set of
bootstrapped prediction outputs, wherein the bootstrapped prediction outputs have different prediction outputs for the same subset of training data;
calculating a prediction variance for each set of the corresponding set of boot strapped prediction outputs; and
estimating the confidence interval based on the prediction variance; and
adjusting the randomness function based on the confidence interval.

12. A system comprising:
a computer processor;
a data repository in communication with the computer processor, wherein the data repository stores:
training data comprising privileged information and non-privileged information,
prediction output,
a reward,
a correct result,
a test output,
a comparison,
a threshold,
an untrained model comprising a contextual bandits one-step reinforcement learning machine learning model;
a trained model trained from the untrained model;
a training controller, wherein the training controller, when executed by the computer processor, performs an iterative process that repeats until convergence, the iterative process comprising:
executing the untrained model on the training data to generate a prediction output, and wherein both the privileged information and the non-privileged information are applied while executing the untrained model,
determining a reward based on the prediction output relative to a correct result,
updating the untrained model according to the reward to generate an updated model,
applying the training data to the updated model to generate a test output, wherein the non-privileged information is applied while applying the training data while excluding application of the privileged information while applying the training data,
comparing the prediction output to the test output to generate a comparison, and
determining whether convergence is achieved, wherein convergence is achieved when the comparison satisfies a threshold,
wherein, upon determining that convergence is achieved, the updated model comprises the trained model; and
a server controller which, when executed by the computer processor, presents the trained model.

13. The system of claim 12, wherein the training controller, when executed by the computer processor, is further programmed to generate a modified trained model by performing, after performing the iterative process, an additional process comprising:
applying a randomness function to the trained model to generate an updated model;
re-executing the updated model on the training data to generate one or more new prediction outputs; and
re-applying the training controller to the updated model and new training data to generate the modified trained model,
wherein the new training data includes at least the one or more new prediction outputs.

14. The system of claim 13, wherein the new training data corresponds to at least one or more subsets of users for which a corresponding prediction output was modified to generate the one or more new prediction outputs.

15. The system of claim 13, wherein the randomness function comprises at least one of an epsilon-greedy algorithm, an upper confidence bound algorithm, and a Thompson sampling algorithm.

16. The system of claim 13, wherein the randomness function further modifies the training data.

17. The system of claim 13, wherein the training controller, when executed by the computer processor, is further programmed to generate a modified retrained model by performing, after performing the re-applying the training controller, an additional process comprising:
applying the modified trained model to unknown data to generate a plurality of inferences; and
re-training, to generate the modified retrained model, the modified trained model on new training data, wherein the new training data comprises at least the unknown data and the plurality of inferences.

18. The system of claim 12, wherein the privileged information corresponds to features relating to one or more existing users.

19. The system of claim 18, wherein the non-privileged information corresponds to initial features of the one or more existing users.

20. A method comprising:
applying a training controller to an untrained model and training data to generate a trained model, wherein:
the untrained model comprises a contextual bandits one-step reinforcement learning machine learning model,
the training data comprises both privileged information and non-privileged information,
wherein applying the training controller comprises an iterative process that repeats until convergence, the iterative process comprising:
executing the untrained model on the training data to generate a prediction output, and wherein both the privileged information and the non-privileged information are applied while executing the untrained model,
determining a reward based on the prediction output relative to a correct result,
updating the untrained model according to the reward to generate an updated model,
applying the training data to the updated model to generate a test output, wherein the non-privileged information is applied while applying the
training data while excluding application of the privileged information while applying the training data,
comparing the prediction output to the test output to generate a comparison, and
determining whether convergence is achieved, wherein convergence is achieved when the comparison satisfies a threshold;
wherein, upon determining that convergence is achieved, the updated model comprises the trained model;
presenting the trained model;
applying the trained model to unknown data to generate a plurality of inferences; and
re-training, to generate a retrained model, the trained model on new training data, wherein the new training data comprises at least the unknown data and the plurality of inferences.
